(19) United States
(12) Patent Application Publication
(10) Pub. No.: US 2013/0179603 A1
(43) Pub. Date: Jul. 11, 2013

(54) APPARATUS AND METHOD OF IDENTIFYING A USB OR AN MHL DEVICE

(71) Applicants: Chun-An Tu, Tainan City (TW); Ke-Ming Lin, Kaohsiung City (TW); Ching-Mei Huang, Hsinchu City (TW)

(72) Inventors: Chun-An Tu, Tainan City (TW); Ke-Ming Lin, Kaohsiung City (TW); Ching-Mei Huang, Hsinchu City (TW)

(21) Appl. No.: 13/721,084

(22) Filed: Dec. 20, 2012

Related U.S. Application Data
(60) Provisional application No. 61/583,620, filed on Jan. 6, 2012.

(51) Int. Cl. G06F 13/00

(52) U.S. Cl. CPC G06F 13/00
USPC 710/15

(57) ABSTRACT

An apparatus and a method of identifying between a USB and an MHL typed devices are disclosed. One embodiment discloses an apparatus for identifying whether the Universal Serial Bus (USB) or the Mobile High-Definition Link (MHL) typed device is attached to a connector by detecting a pull-down resistor when the USB device is actually attached to the connector. A resistor-detecting module and a switch are connected in series to form a conductive path to detect if there is a pull-down resistor connected from a data pin to a voltage-reference pin of the connector when the switch is turned on. Once the device is identified, an internal data path can be established according to the device type.

### CROSS REFERENCE TO RELATED APPLICATIONS

This application claims the benefit of priority of U.S. Provisional Application No. 61/583,620, filed Jan. 6, 2012 and titled “Source device detects USB/MHL attachment using differential signals”, the contents of which are herein incorporated by reference in its entirety.

### BACKGROUND OF THE INVENTION

1. Field of the Invention

The present invention relates to a device attached to a system through a connector and, in particular, to a method for identifying the attached device.

2. Description of the Prior Art

The USB standard was developed in the mid-1990s. It was designed to connect computer peripherals, such as mice, keyboards, printers and network adapters, to a computer. Today, USB has become a widely-used standard for connecting a variety of electronic devices. The MHL standard is used for connecting mobile phones or other portable consumer electronics (CE) devices to a high-definition display. The MHL standard can support USB interface as well. For example, a 5-pin MHL-USB connector is an implementation for micro USB. An electronic device supporting both the USB and the MHL devices can take advantage of the MHL-USB connector to connect either a USB or a MHL device. However, in order for a single connector to support both USB and MHL, it is necessary to know which device is currently attached through the connector. Therefore, how to differentiate a USB from an MHL device on a MHL-USB connector is desired.

### SUMMARY OF THE INVENTION

One object of the present invention is to identify if there is a USB or an MHL device attached to a connector.

One embodiment discloses an apparatus for identifying an attached device as a USB typed or an MHL typed device by turning on a switch connected to a differential data pin and measuring a voltage level at the differential data pin, wherein a conductive path is formed from a voltage-supply node, through a resistor-detecting module and the switch, to the differential data pin when the switch is turned on, wherein the attached device is a USB typed device when the voltage level at the differential data pin is less than a pre-defined voltage level and the device is an MHL typed device if the voltage level at the differential data pin is not less than the pre-defined voltage level.

The apparatus further includes a multiplexer to select either a USB transceiver or an MHL transmitter according to the voltage at the data pin when the switch is turned on, wherein the USB transceiver is selected if the voltage at the data pin is lower than a pre-determined voltage. The apparatus further includes a detecting circuit to check whether there is a pull-down resistor attached to a control bus line for identifying an MHL device.

One embodiment discloses a method for identifying whether a device is a universal serial bus (USB) typed or a mobile high-definition link (MHL) typed device, wherein the device is connected to the apparatus through a connector comprising a first data pin, a voltage-supply pin, a voltage-reference pin and a control pin, comprising the steps of: providing a first switch; providing a first resistor-detecting module, wherein the first resistor-detecting module and the first switch are connected in series; turning on the first switch to establish a first conductive path from a first voltage-supply node, through the first resistor-detecting module and the first switch, to the first data pin; and comparing the voltage level of the first data pin to a first pre-defined voltage level when the first switch is turned on.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings.

FIG. 1A is a schematic block diagram of a source electronic device comprising a resistor-detecting module and a switch connected in series to detect a pull-down resistor in accordance with one embodiment of the present invention.

FIG. 1B shows the schematic block diagram of the source electronic device in FIG. 1A with the resistor-detecting module and the switch swapped.

FIG. 2A depicts a working flow of identifying a USB or an MHL device attached to a source electronic device in accordance with one embodiment of the present invention.

FIG. 2B shows a flow chart of checking whether a differential data line feature is related to USB in accordance with one embodiment of the present invention.

FIG. 2C is a flow chart of trying to switch to the USB mode in accordance with one embodiment of the present invention.

FIG. 2D is a flow chart of checking whether a differential data line feature is related to MHL in accordance with one embodiment of the present invention.

FIG. 2E is a flow chart of trying to switch to the MHL mode in accordance with one embodiment of the present invention.

FIG. 2F is a flow chart of detecting VBUS line status in accordance with one embodiment of the present invention.

FIG. 3A is a schematic block diagram of a source electronic device when a USB device is attached to the source electronic device in one embodiment of the present invention.

FIG. 3B depicts a timing diagram of a VBUS signal and a pair of differential data signals in FIG. 3A.

FIG. 3C illustrates one type of a resistor-detecting module using a pull-up resistor.

FIG. 3D illustrates one type of the resistor-detecting module using a pull-up resistor in series with a diode.

FIG. 4A is a schematic block diagram of a source electronic device when an MHL device is attached to the source electronic device in one embodiment of the present invention.

FIG. 4B depicts a timing diagram of a VBUS signal and a pair of differential data signals in FIG. 4A.

FIG. 4C is a schematic block diagram of a first embodiment of a resistor-detecting module using a pull-up resistor.

FIG. 4D is a schematic block diagram of a second embodiment of a resistor-detecting module using a pull-up resistor in series with a diode.

FIG. 5A is a schematic block diagram of a source electronic device when a MHL device is attached to the source electronic device in another embodiment of the present invention.

FIG. 5B depicts a timing diagram of a VBUS signal, a CBUS signal and a pair of differential data signals in FIG. 5A.

FIG. 5C illustrates one type of the impedance-detecting module comprises two comparators and a pull-up resistor in FIG. 5A.

FIG. 5D illustrates one type of the impedance-detecting module comprises a comparator, two switches and two pull-up resistors in FIG. 5A.

FIG. 6A illustrate a flow chart for identifying whether a device is a universal serial bus (USB) typed or a mobile high-definition link (MHL) typed device using a differential data line in accordance with one embodiment of the present invention.

FIG. 6B illustrate a flow chart for identifying whether a device is a universal serial bus (USB) typed or a mobile high-definition link (MHL) typed device using a differential data line or a control bus line in accordance with one embodiment of the present invention.

### DETAILED DESCRIPTION OF THE PREFERRED EMBODIMENT

The detailed explanation of the present invention is described as the following. The described preferred embodiments are presented for purposes of illustrations and description, and they are not intended to limit the scope of the present invention.

The apparatus for identifying whether a device is a USB typed or an MHL typed device comprises a first switch and a first resistor-detecting module connected in series. A first conductive path is formed from a first voltage-supply node through the first resistor-detecting module and the first switch, to the first data pin to detect if there is a first pull-down resistor connected from a first data pin to a voltage-reference pin when the first switch is turned on.

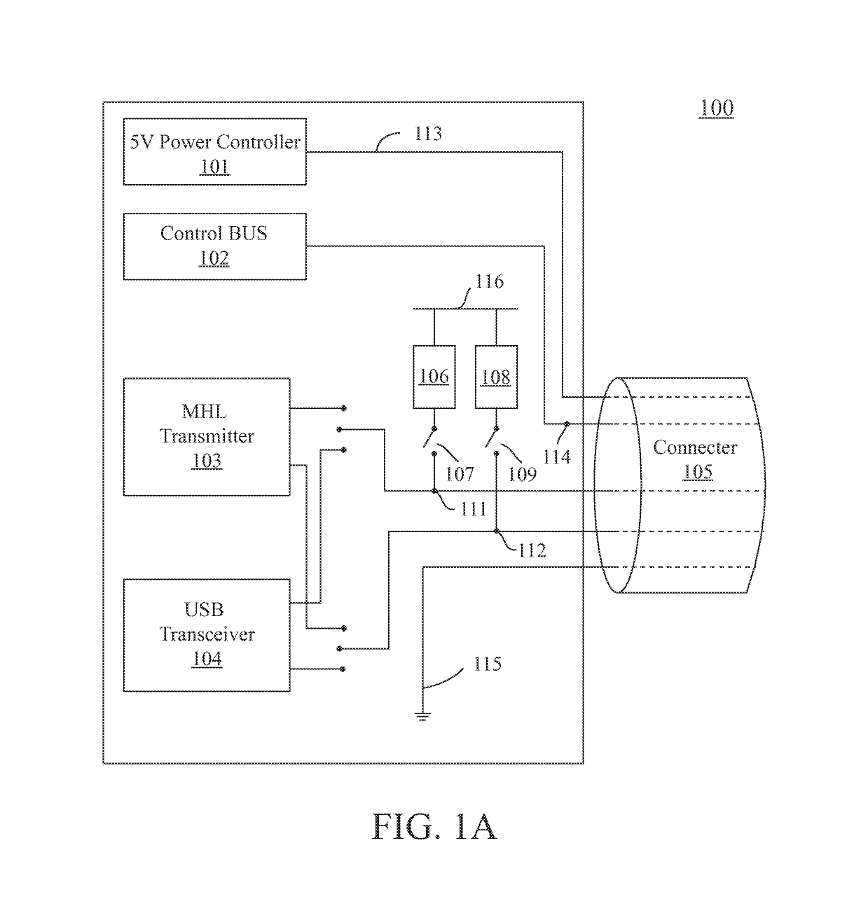

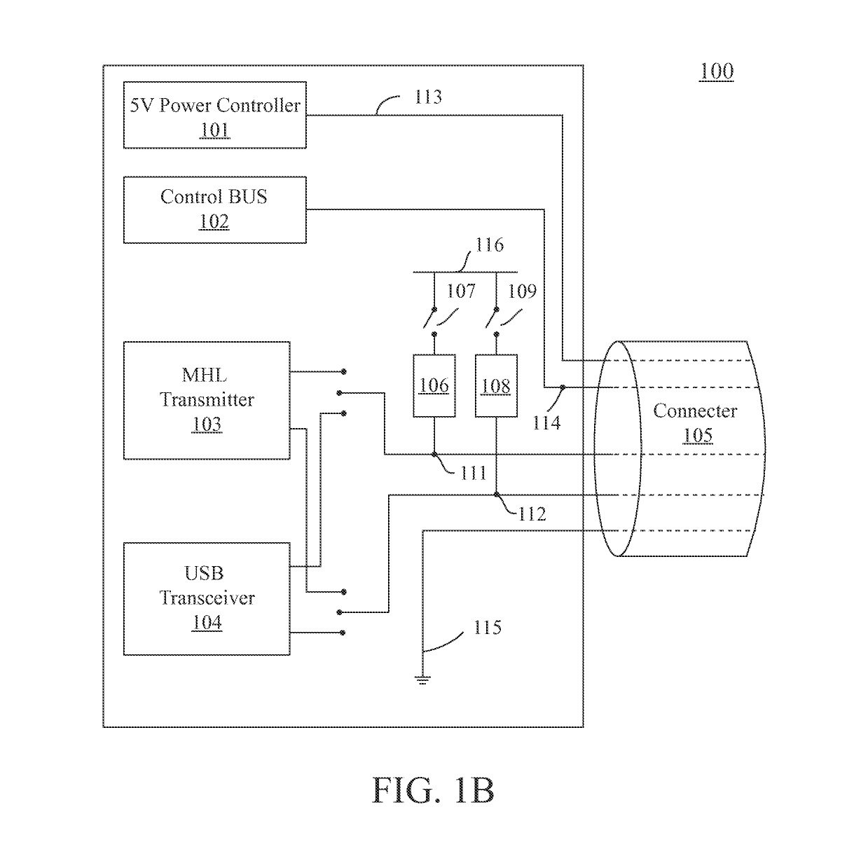

FIG. 1A shows a schematic block diagram of a source electronic device with a connector for connecting to an external device. The source electronic device 100 has a 5V power controller 101, a control bus 102, an MHL transmitter 103 and a USB transceiver 104, wherein a—connecter 105 is used for connecting to an external device. The connector 105 includes a VBUS line 113, a control pin 114, a first differential data pin 111 and a second differential data pin 112, wherein the first differential data pin 111 and the second differential data pin 112 are used for connecting a pair of differential signals. A resistor-detecting module 106 and a switch 107 are connected in series between a voltage source 116 and the first differential data pin 111; a resistor-detecting module 108 and a switch 109 are connected in series between a voltage source 116 and the second differential data pin 112. Please note that the resistor-detecting module 106 and the switch 107 can be connected in other ways like the one shown in FIG. 1B in which the resistor-detecting module 106 and the switch 107 are swapped compared with FIG. 1A. Likewise, the resistor-detecting module 108 and the switch 109 can also be swapped as in FIG. 1B compared with FIG. 1A.

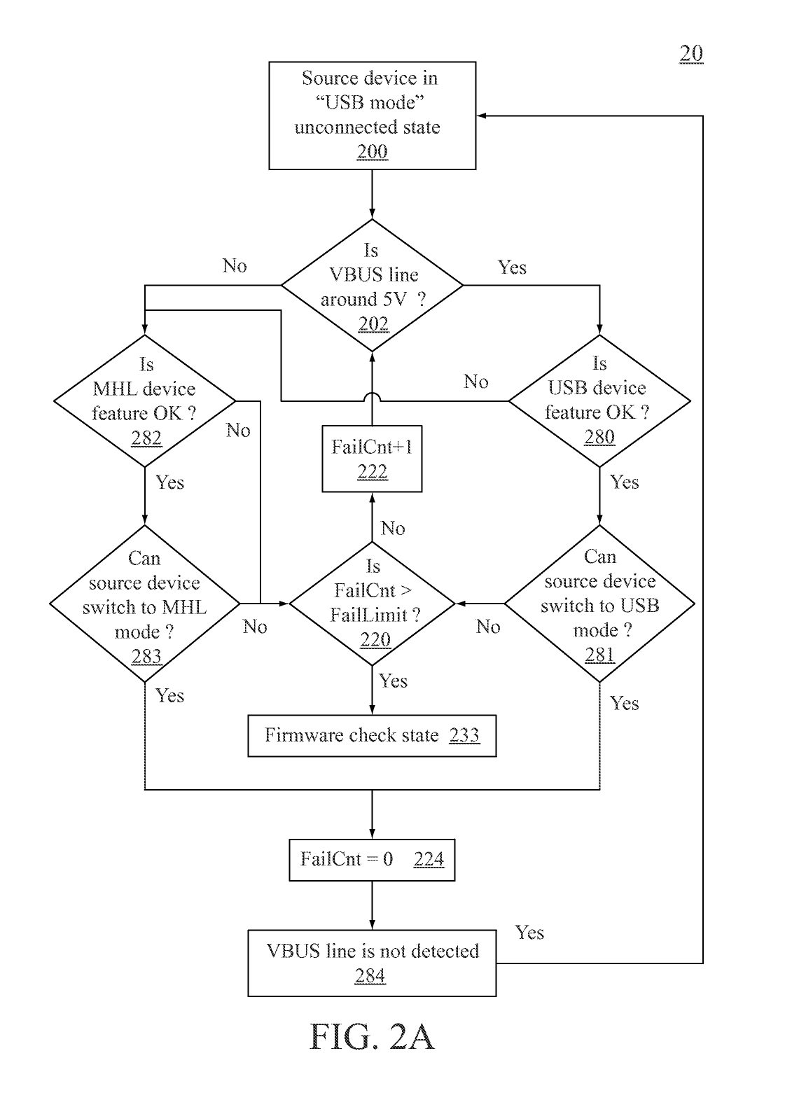

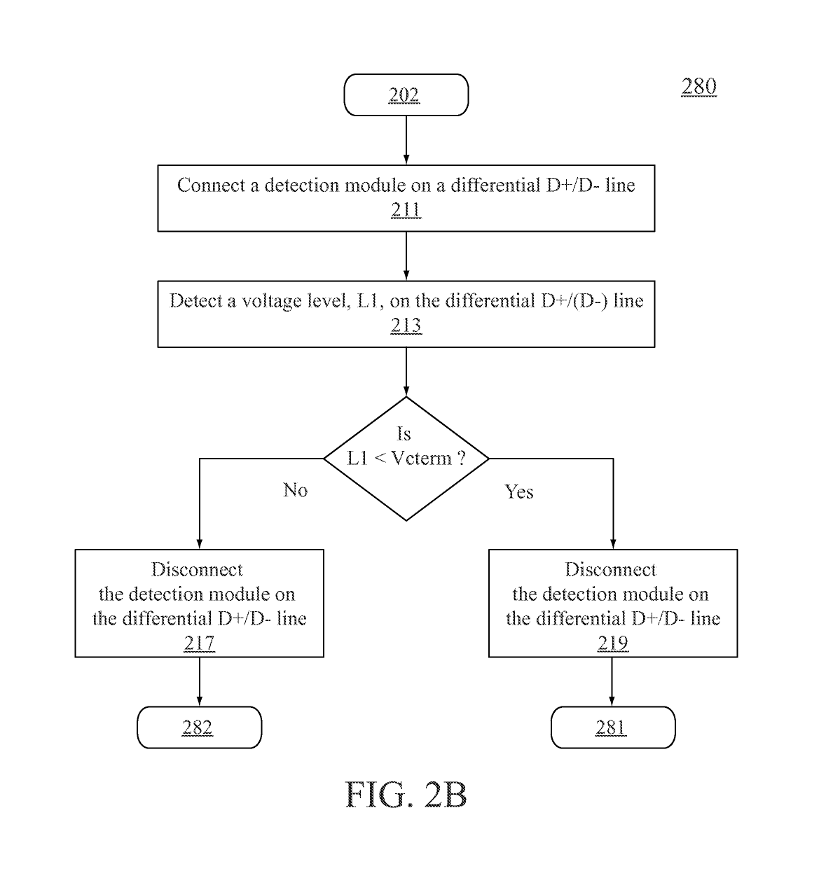

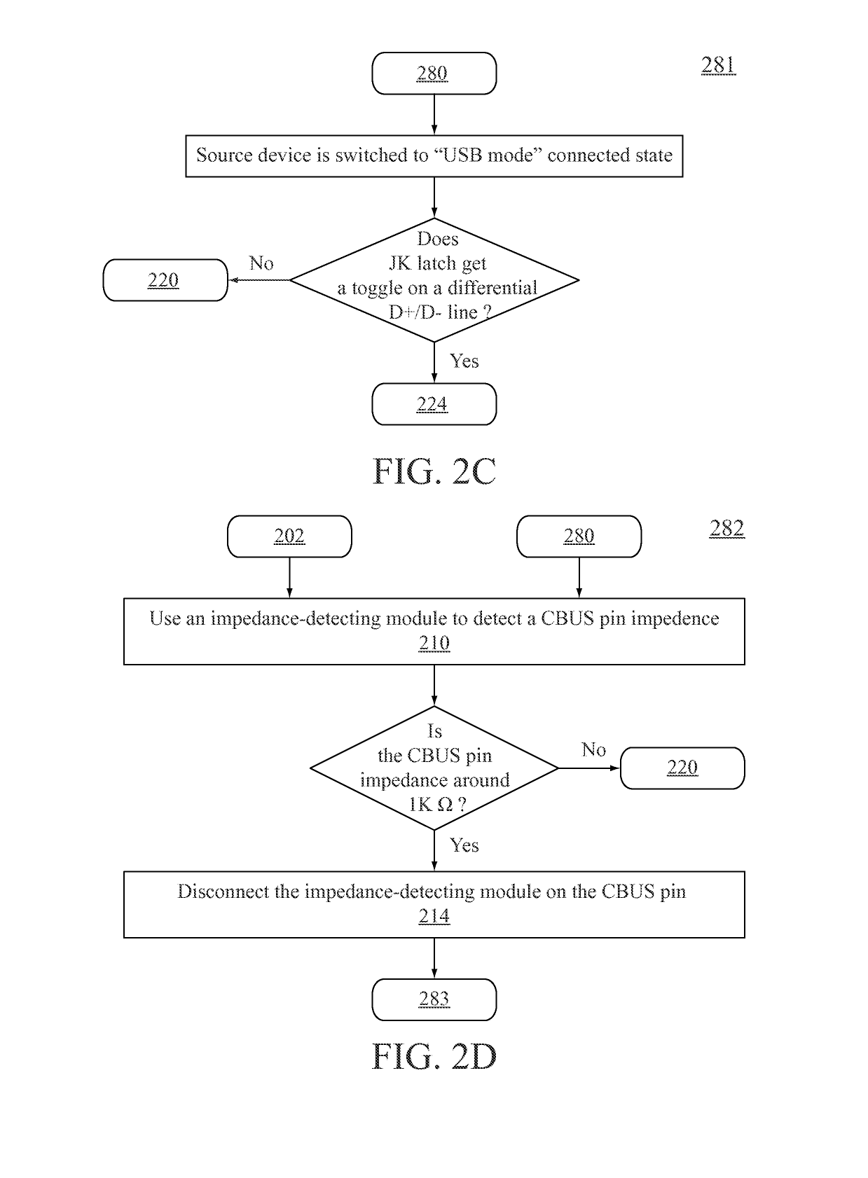

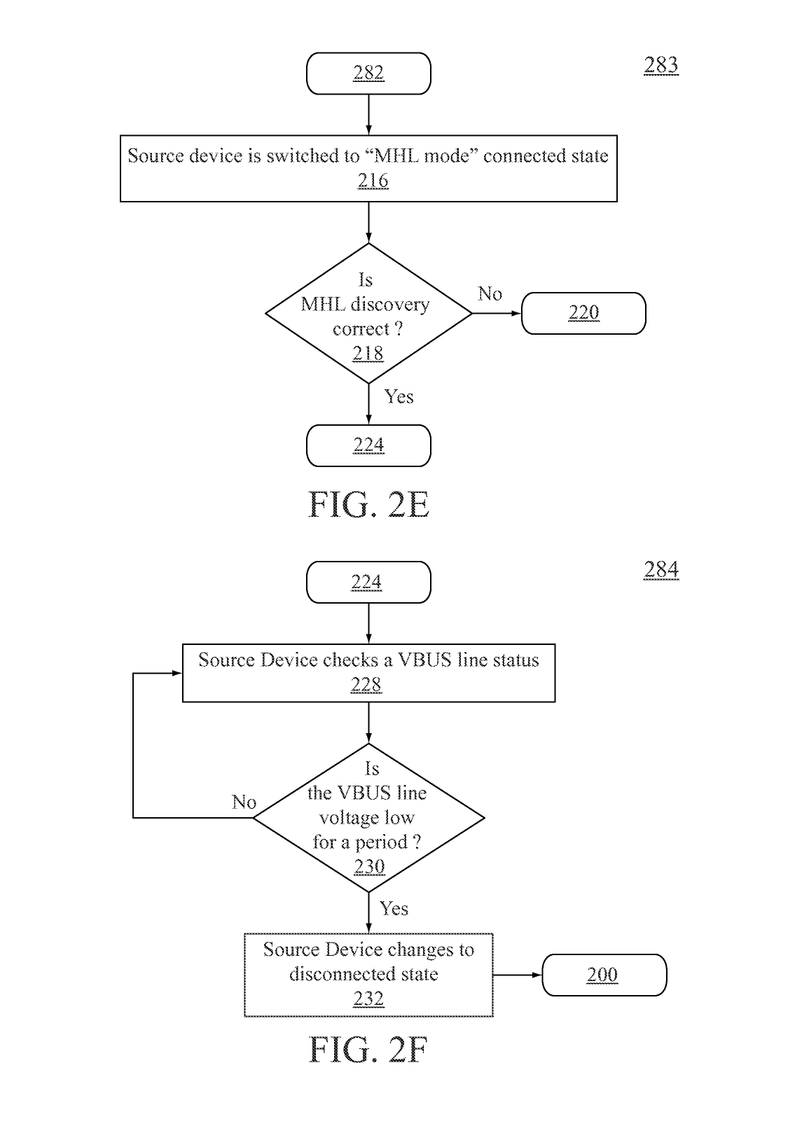

FIG. 2A depicts a working flow of identifying a USB or an MHL device attached to a source electronic device. The source electronic device is initially in a “USB mode” unconnected state (block 200), and then checks whether the VBUS line is around 5V (block 202). If the VBUS line is around 5V, the source electronic checks whether the attached device feature is related to USB (block 280); otherwise, it checks whether the attached device feature is related to MHL (block 282). In the block 280, if the attached device feature is related to USB, the source electronic device tries to switch to the USB mode (block 281); otherwise, it checks whether the attached device feature is related to MHL (block 282), wherein if indeed the attached device feature is related to MHL, the source device tries to switch to the MHL mode (block 283). If the source electronic device cannot switch to either the USB mode in block 281 or the MHL mode in block 283 successfully, the current FailCnt will be compared to a FailLimit (block 220). If the FailCnt is not larger than the FailLimit, the FailCnt (block 222) is increased by one and the next step goes back to block 202 again, otherwise, it will go to firmware check state (block 233). If the source electronic device switches to either the USB mode in block 281 or the MHL mode in block 283 successfully, it clears the FailCnt (block 224) and checks if the VBUS line is not connected to the source electronic device (block 284). In block 284, when the VBUS line is not connected to the source electronic device, it loops back to block 200.

To further explain the steps in block 280 of FIG. 2A, please refer to FIG. 2B which shows a flow chart of checking whether the attached device feature is related to USB. After the VBUS line is detected around 5V, the voltage of a differential data line D+ or D− will be determined by the following mechanism. A switch in series with a resistor are connected to the differential data line D+ or D−, as shown in block 211, to detect a voltage level, L1, on the differential data line D+ or D− when the switch is turned on as shown in block 213. If L1 is less than a predefined voltage level, Vcterm, then we can determine that there is a pull-down resistor connected to the differential data line D+ or D− and the USB typed device is detected. Then, the switch can be turned off to disconnect the resistor-detecting module from the differential data line D+ or D− (block 219) and the next step goes to block 281 in FIG. 2A. If L1 is not less than Vcterm, the switch can be turned off to disconnect the resistor-detecting module from the differential data line D+ or D− (block 217) and the next step goes to block 282 in FIG. 2A to check whether the feature of the attached device is related to MHL. To further explain the steps in block 281 of FIG. 2A, please refer to FIG. 2C which shows a flow chart of trying to switch to the USB mode. First, the source electronic device is switched to connect a USB type device, and then the signal on the differential data line, D+ or D−, will be checked to see if there is a toggle in the signal by using a JK latch to latch the signal. If there is a toggle, the next step goes to block 224 in FIG. 2A; otherwise, it goes to block 220 in FIG. 2A.

To further explain the steps in block 282 of FIG. 2A, please refer to FIG. 2D which shows a flow chart of checking whether the attached device feature is related to MHL. An impedance-detecting module is used to detect the impedance of the CBUS line (block 210). If the impedance of the CBUS line is around 1K ohms, the attached device is considered as an MHL typed device, and then the impedance-detecting module is disconnected (block 214) and goes to block 283 in FIG. 2A; otherwise, it goes to block 220 in FIG. 2A.

To further explain the steps in block 283 of FIG. 2A, please refer to FIG. 2E which shows a flow chart of trying to switch to the MHL mode. First, the source electronic device is switched to the “MHL mode” (block 216), and then checks if MHL discovery is correct (block 218). If the MHL discovery is correct, the next step goes to block 224 in FIG. 2A to clear the FailCnt; otherwise, it goes to block 220 in FIG. 2A.

To further explain the steps in block 284 of FIG. 2A, please refer to FIG. 2F which shows a flow chart of detecting the VBUS line status. Continuing from block 224 in FIG. 2A, first, the source electronic device checks the VBUS line status (block 228). Then, if a voltage level of the VBUS line is low for a period (block 230), the source electronic device changes to disconnected state (block 232), and then loops back to block 200 in FIG. 2A.

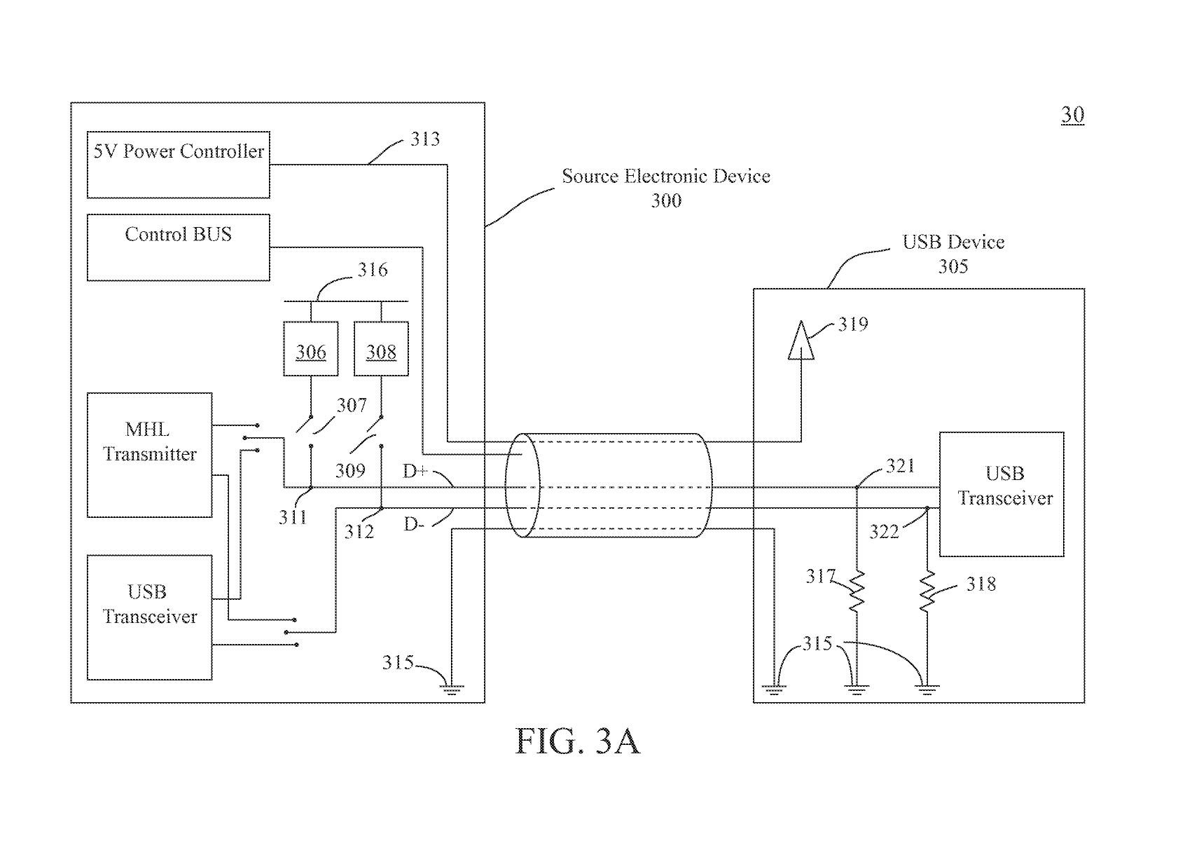

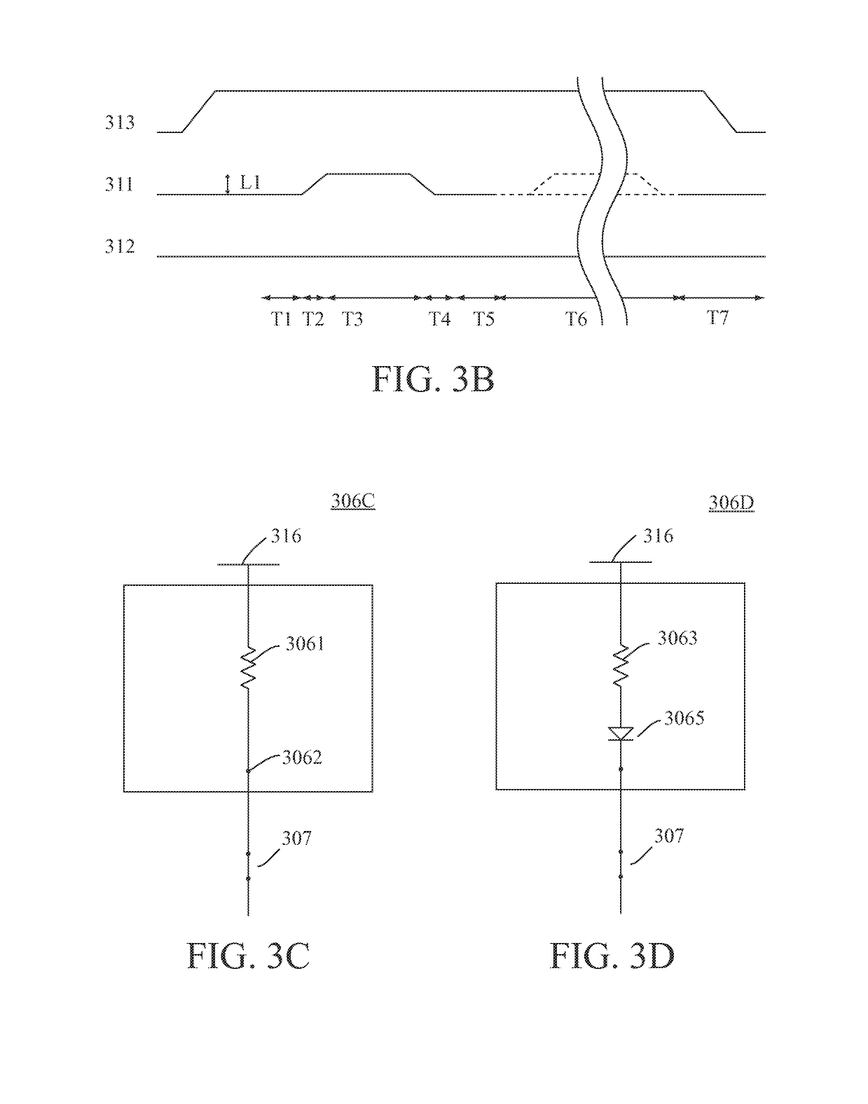

In one embodiment, a source electronic device 300 connected to a USB device 305 is shown in FIG. 3A. A conductive path is formed from a voltage source 316, through a resistor-detecting module 306 and a switch 307 connected in series, to a differential data pin 311 which extends to a differential data pin 321 in the USB device 305, wherein a pull-down resistor 317 is connected from the differential data pin 321 to a ground pin 315. Likewise, another conductive path is formed from the voltage source 316, through a resistor-detecting module 308 and a switch 309 connected in series, to a differential data pin 312 which extends to a differential data pin 322 in the USB device 305, wherein a pull-down resistor 318 is connected from the differential data pin 322 to the ground pin 315. A VBUS line 313 is connected to a voltage node 319.

FIG. 3B shows a corresponding timing diagram of the VBUS line 313, the differential data pin 311 and the differential data pin 312. First, the switch 307 is turned off in a first time period T1. Then, the switch 307 is turned on in a second time period T2. Due to the pull-down resistor 317 on the differential data pin 311, the voltage at the differential data pin 311 will rise to L1, which is less than the Vcterm, in a third time period T3. Then, the switch 307 is turned off in a fourth time period T4. The source electronic device 300 will be switched to the USB mode in a fifth time period T5. The aforementioned time waveforms can be repeated again, which can be observed from a sixth time period T6 till a seventh time period T7.

The resistor-detecting module 306 to detect the pull-down resistor 317 can be in many forms. A resistor-detecting module 306C includes a pull-up resistor 3061 as shown in FIG. 3C, and the pull-up resistor 3061 and the pull-down resistor 317 form a voltage divider between the voltage-supply node 316 and the ground 315 when the switch 307 is turned on. That is, a voltage level of the measured point 3062 is between the voltage at the voltage-supply node 316 and the ground 315. Please note that the ratio of the resistance of the pull-up resistor 3061 to the pull-down resistor 317 can be pre-defined. For example, if the ratio is 2:1, the voltage level at the measured point 3062 should be around one third of the voltage at a voltage source connected to the pull-up resistor 3061. Therefore, a pre-defined voltage, which is one third of the voltage level of the voltage source connected to the pull-up resistor 3061, can be used to compare with the measured voltage level at a differential data line. Accordingly, the attached device is a USB typed device when a voltage level at the measured data pin is less than a pre-defined voltage level and the device is a MHL typed device if the voltage level at the measured data pin is not less than the pre-defined voltage level.

A resistor-detecting module 306D includes a pull-up resistor 3063 and a diode 3065 in series as shown in FIG. 3D. The operation will be the same except that there is a cut-in voltage, such as 0.3V, drop through the diode 3065. In this case, a predefined voltage can be chosen by taking the cut-in voltage drop into consideration.

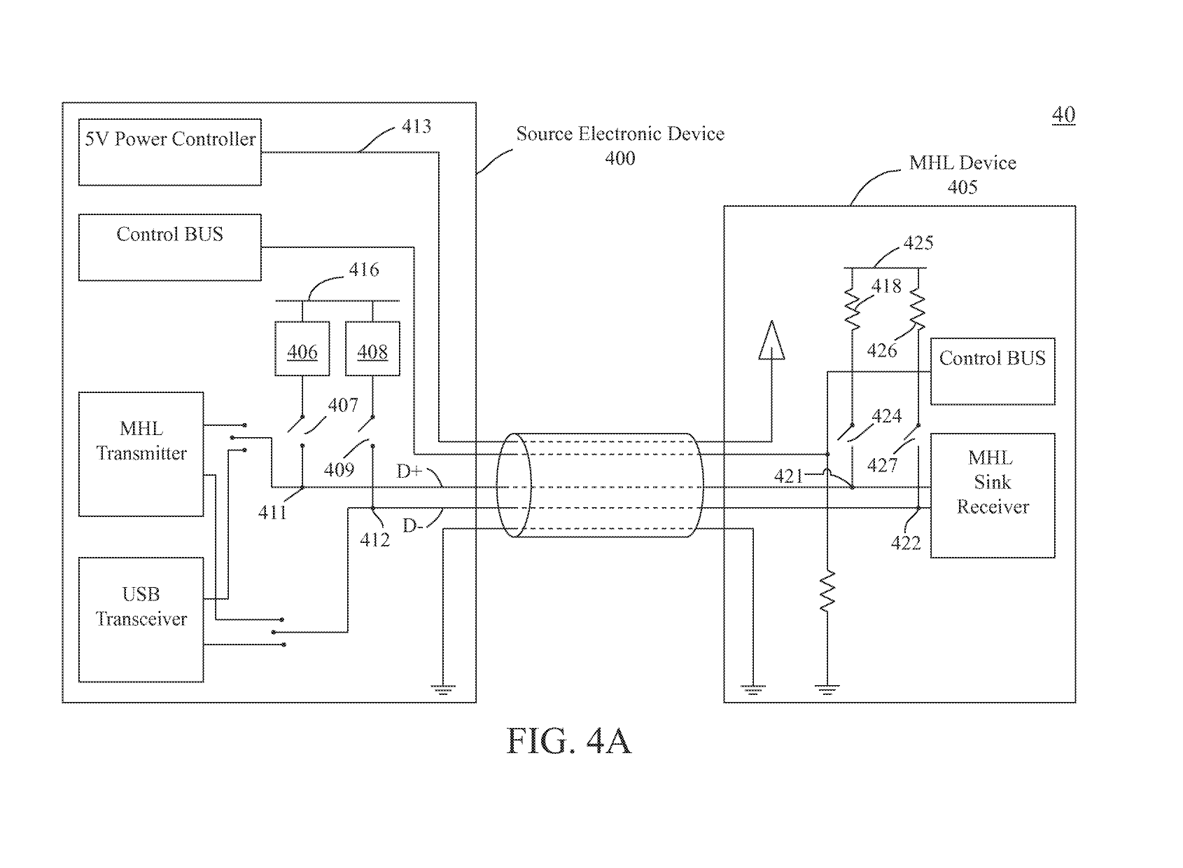

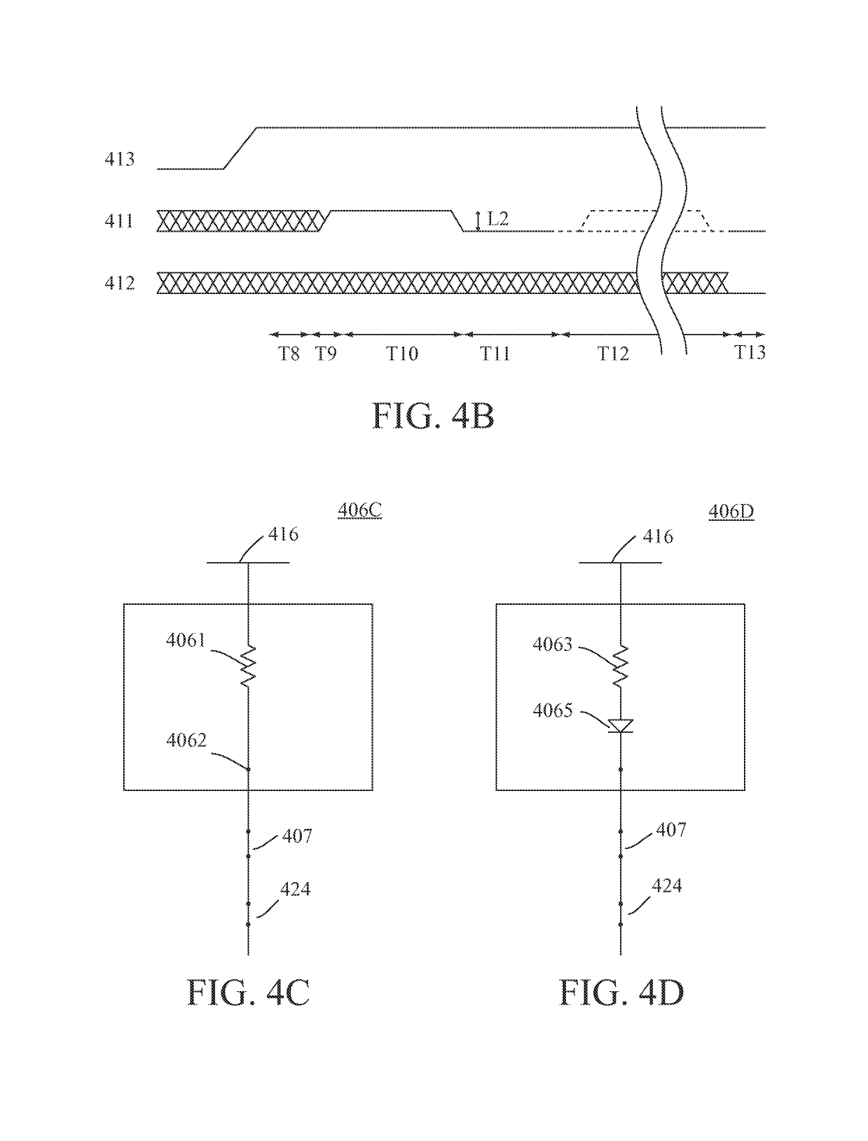

In one embodiment, a source electronic device 400 is connected to a MHL type device 405 as shown in FIG. 4A. A conductive path is formed from a voltage source 416, through a resistor-detecting module 406 and a switch 407 connected in series, to a differential data pin 411 in the source electronic device 400, wherein the differential data pin 411 extends to a differential data pin 421 in the MHL device 405, wherein a switch 424 and a pull-up resistor 418 are connected from a voltage source 425 to the differential data pin 421. Likewise, another conductive path is formed from the voltage source 416, through a resistor-detecting module 408 and a switch 409 connected in series, to a differential data pin 412 in the source electronic device 400, wherein the differential data pin 412 extends to a differential data pin 422 in the MHL device 405, wherein a switch 427 and a pull-up resistor 426 are connected from the voltage source 425 to the differential data pin 422.

FIG. 4B shows a timing diagram of a VBUS line 413, the differential data pin 411 and the differential data pin 412. First, the switch 407 is turned off in an eighth time period T8. Then, the switch 407 is turned on in a ninth time period T9. Due to the pull-up resistor 406 on the differential data pin 411, the voltage at the differential data pin 411 will rise to L2, which is not less than the Vcterm, in a tenth time period T10. Then, the switch 407 is turned off in an eleventh time period T11 and the source electronic device 400 will be switched to the MHL mode. The CBUS line impedance can be detected to be around 1K ohms in the time period T11 as well. The aforementioned time waveforms can be repeated again, which can be observed from a twelfth time period T12 till a thirteenth time period T13.

The resistor-detecting module 406 to detect the pull-up resistor 418 can be in many forms. A resistor-detecting module 406C includes a pull-up resistor 4061 as shown in FIG. 4C. The voltage level at a measured point 4062, connecting to the differential data pin 411, will be not less than Vcterm because there is no pull-down resistor connected to the differential data pin 411. The attached device is not a USB typed device, and it can be a MHL typed device.

A resistor-detecting module 406D includes a pull-up resistor 4063 and a diode 4065 in series as shown in FIG. 4D. The operation will be the same except that there is a cut-in voltage, such as 0.3V, drop through the diode 4065. In this case, a predefined voltage can be chosen by taking the cut-in voltage drop into consideration.

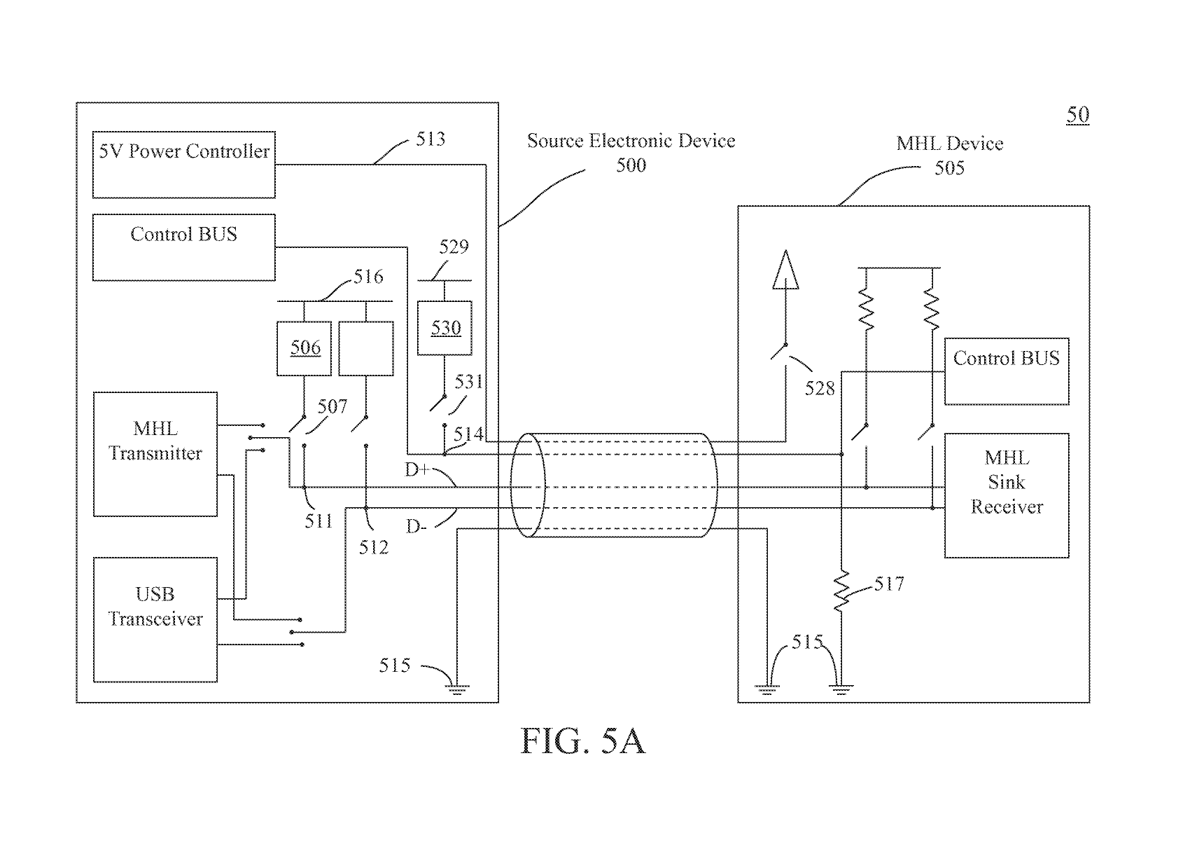

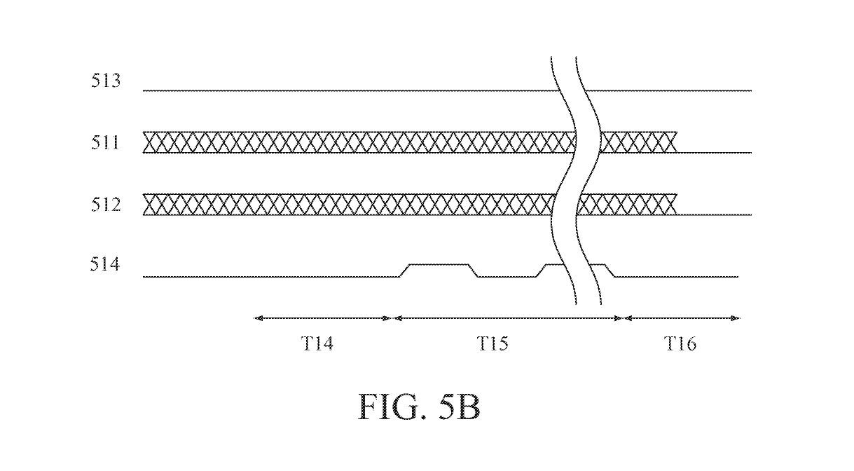

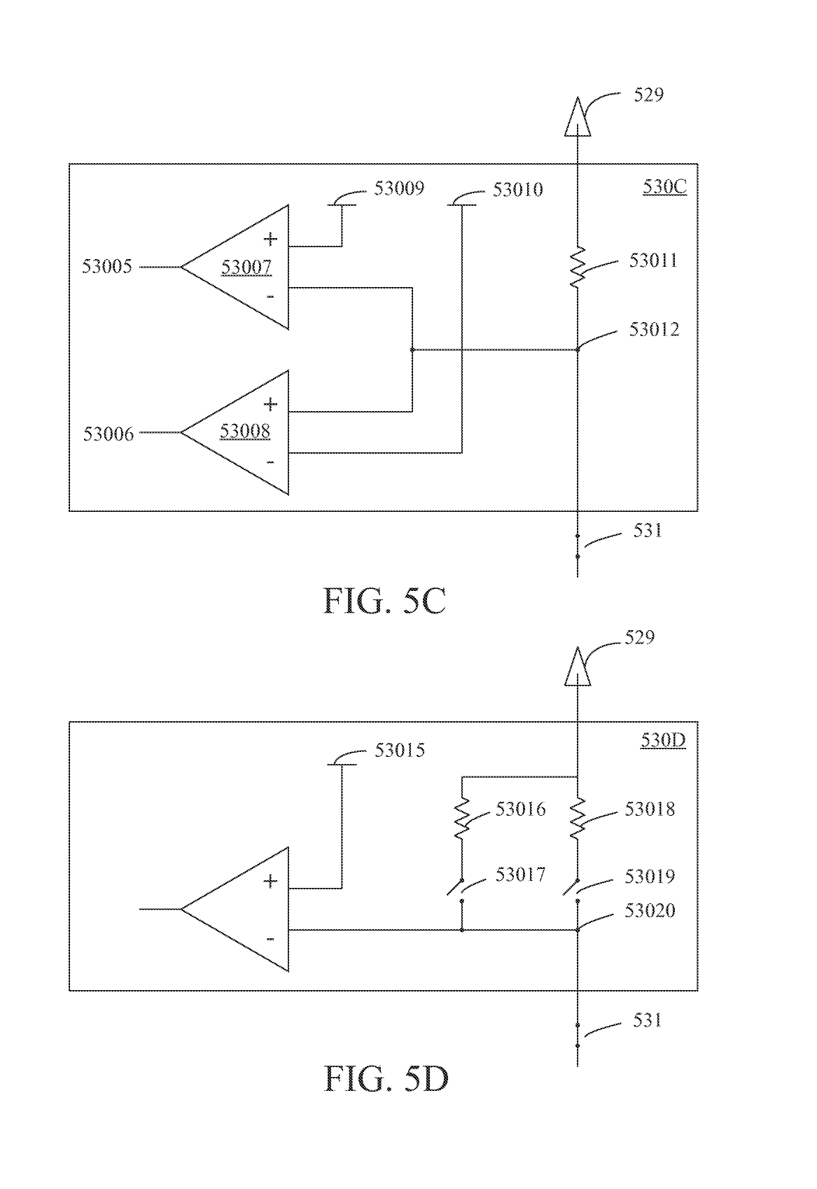

In one embodiment, a source electronic device 500 is connected to a MHL type device 505 as shown in FIG. 5A. A conductive path is formed from a voltage source 529, through an impedance-detecting module 530 and a switch 531 connected in series, to a CBUS pin 514, wherein a pull-down resistor 517, is connected from the CBUS pin 514 to a ground pin 515. FIG. 5B shows a timing diagram of a VBUS line 513, a differential data pin 511, and a differential data pin 512 and the CBUS pin 514. In a time period T14, a voltage level of the VBUS line 513 of the source electronic device 500 is at a low voltage level due to the fact that a switch 528 is turned off. Next, the switch 531 is turned on to form a conductive path from the voltage node 529, through the impedance-detecting module 530 to the ground pin 515 to detect the pull-down resistor 517 in a time period T15. Finally, the MHL mode is selected in a time period T16.

One type of the impedance-detecting module 530 is shown in FIG. 5C. A conductive path is formed from the voltage source 529, through a pull-up resistor 53011, the switch 531 and the pull-down resistor 517, to the ground pin 515 when the switch 531 is turned on. A first comparator 53007 compares a voltage level of a first voltage source 53009 to a voltage level at a measured point 53012 to output a first result 53005; and a second comparator 53008 compares a voltage level at the measured point 53012 to a voltage level of a second voltage source 53010 to output a second result 53006. If the first result 53005 and the second result 53006 match certain predefined pattern, the resistance of the pull-down resistor 517 is around 1K ohms.

One type of the impedance-detecting module 530 is shown in FIG. 5D. A first conductive path is formed from the voltage source 529, through a pull-up resistor 53016, a switch 53017 and the pull-down resistor 517, to the ground pin 515 when the switch 53017 is turned on and a switch 53019 is turned off if the switch 531 is turned on. A second conductive path is formed from the voltage source 529, through a pull-up resistor 53018, the switch 53019 and the pull-down resistor 517, to the ground pin 515 when the switch 53017 is turned off and the switch 53019 is turned on if the switch 531 is turned on. A first voltage level at a measured point 53020 is VC1 when the first conductive path is conducting; and a second voltage level at the measured point 53020 is VC2 when the second conductive path is conducting. If the VC1 is less than a reference voltage, Vkterm, which can be provided by a voltage source 53015, and VC2 is larger than the Vkterm, the resistance of the pull-down resistor 517 is around 1K ohms given that the pull-up resistor 53016 resistance is larger than the pull-up resistor 53018 resistance.

Please note that, in FIG. 5A, a conductive path is formed from a voltage source 516, through a resistor-detecting module 506 and a switch 507 connected in series, to the differential data pin 511 when the switch 507 is turned on, and a voltage level at the differential data pin 511 is around a voltage level of the voltage source 516. Therefore, it is higher than the voltage level of the differential data pin 311 in FIG. 3A.

That is, we can determine an attached device is a USB typed or an MHL typed device by turning on a switch connected to a differential data pin and measuring a voltage level at the differential data pin, wherein a conductive path is formed from a voltage-supply node, through a resistor-detecting module and the switch, to the differential data pin when the switch is turned on, wherein the attached device is the USB typed device when the voltage level at the differential data pin is less than a pre-defined voltage level and the device is the MHL typed device if the voltage level at the differential data pin is not less than the pre-defined voltage level.

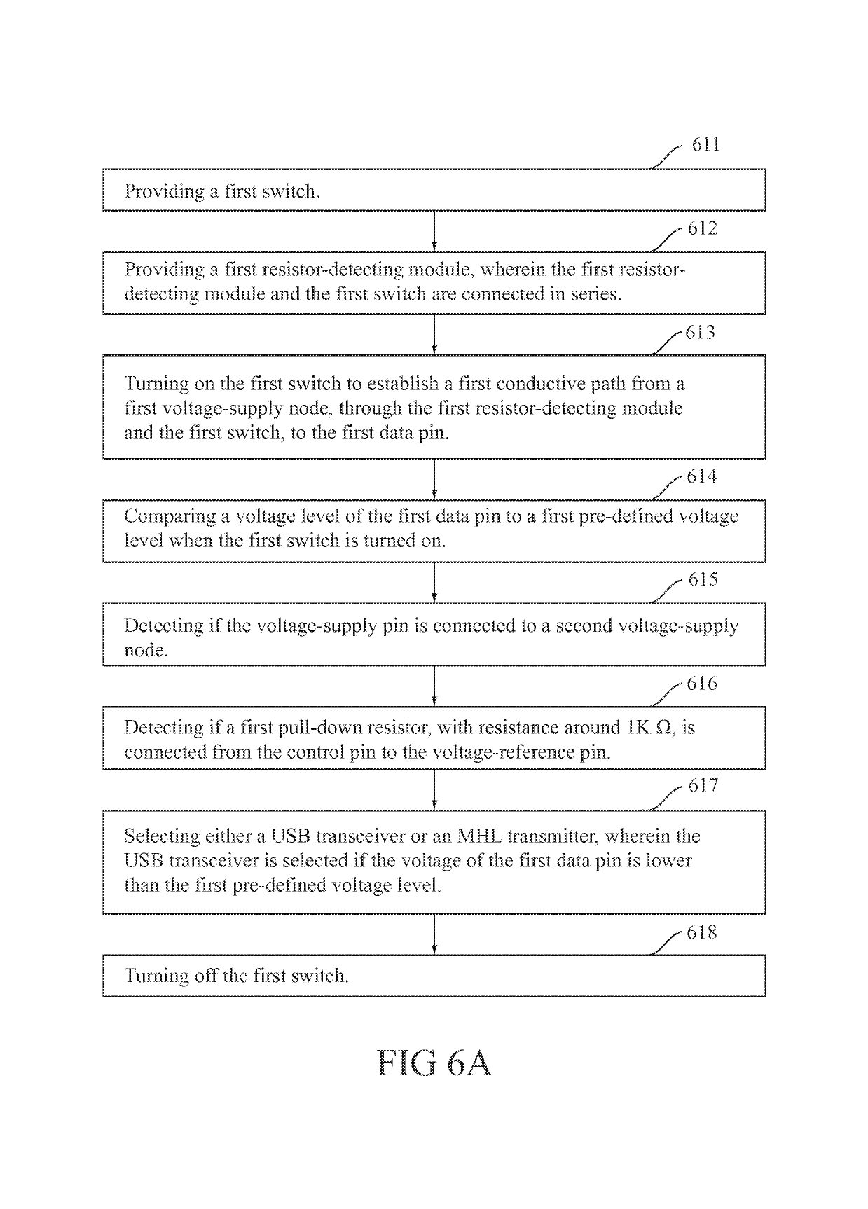

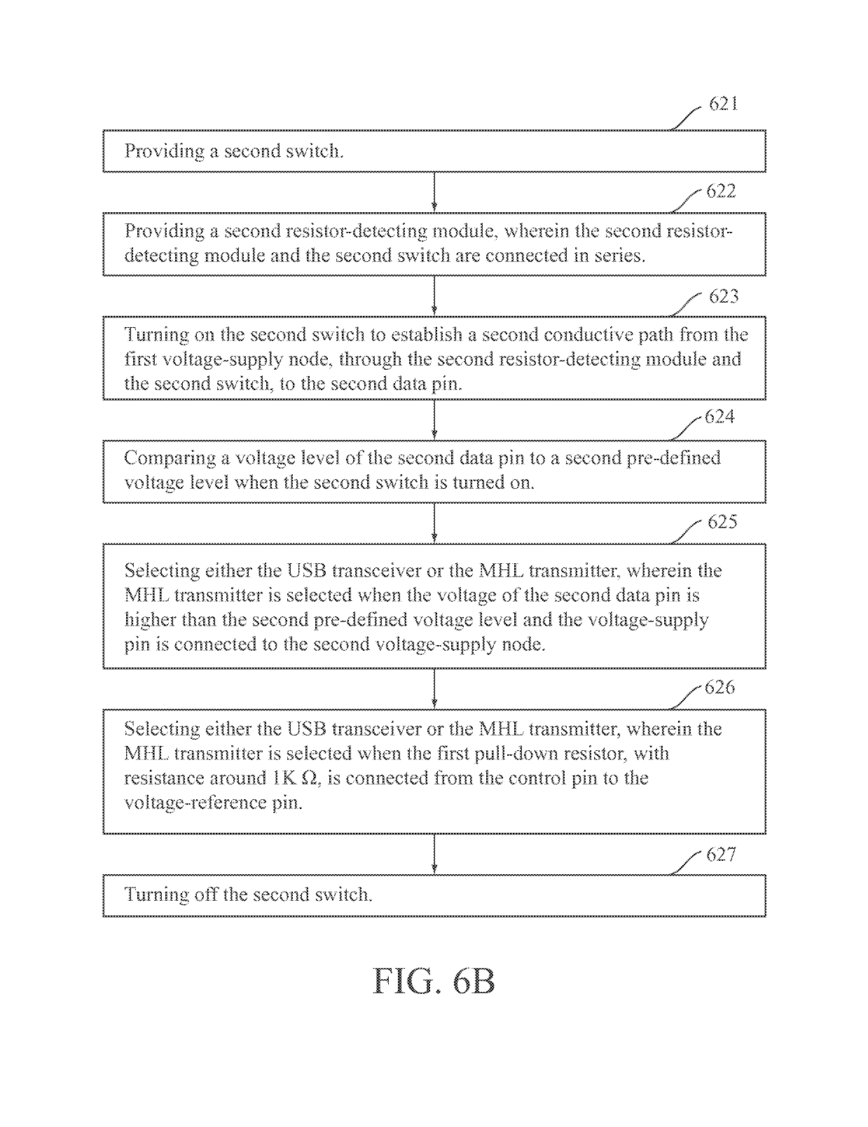

In one embodiment, as shown in FIG. 6A, a method for identifying whether a device is the universal serial bus (USB) typed or the mobile high-definition link (MHL) typed device, wherein the device is connected to an apparatus through a connector comprising a first data pin, a voltage-supply pin, a voltage-reference pin and a control pin, comprising the steps of: providing a first switch (step 611); providing a first resistor-detecting module, wherein the first resistor-detecting module and the first switch are connected in series (step 612); turning on the first switch to establish a first conductive path from a first voltage-supply node, through the first resistor-detecting module and the first switch, to the first data pin (step 613); comparing a voltage level of the first data pin to a first pre-defined voltage level when the first switch is turned on (step 614), wherein the device is the USB typed device when a voltage level at the first data pin is less than the first pre-defined voltage level and the device is the MHL typed device if the voltage level at the first data pin is not less than the first pre-defined voltage level.

Furthermore, in one embodiment, the following steps can be performed: detecting if the voltage-supply pin is connected to a second voltage-supply node (step 615); detecting if a first pull-down resistor, with resistance around 1K ohms, is connected from the control pin to the voltage-reference pin (step 616); selecting either a USB transceiver or an MHL transmitter, wherein the USB transceiver is selected if the voltage of the first data pin is lower than the first pre-defined voltage level (step 617); turning off the first switch (block 618).

In one embodiment as shown in FIG. 6B, a method for identifying whether the device is the universal serial bus (USB) typed or the mobile high-definition link (MHL) typed device, wherein the device is connected to the apparatus through the connector comprising the first data pin, a second data pin, wherein the first data pin and the second data pin form a pair of differential signals, the voltage-supply pin, the voltage-reference pin and the control pin, comprising the steps of: providing a second switch (step 621); providing a second resistor-detecting module, wherein the second resistor-detecting module and the second switch are connected in series (step 622); turning on the second switch to establish a second conductive path from the first voltage-supply node, through the second resistor-detecting module and the second switch, to the second data pin (step 623); comparing a voltage level of the second data pin to a second pre-defined voltage level when the second switch is turned on (step 624), wherein the device is the USB typed device when the voltage level at the second data pin is less than the second pre-defined voltage level and the device is a MHL typed device if the voltage level at the second data pin is not less than the second pre-defined voltage level.

Furthermore, in one embodiment, the following steps can be performed: selecting either the USB transceiver or the MHL transmitter, wherein the MHL transmitter is selected when the voltage of the second data pin is higher than the second pre-defined voltage level and the voltage-supply pin is connected to the second voltage-supply node (step 625); selecting either the USB transceiver or the MHL transmitter, wherein the MHL transmitter is selected when the first pull-down resistor, with resistance around 1K ohms, is connected from the control pin to the voltage-reference pin (step 626); turning off the second switch (step 627).

What is claimed is:

1. An apparatus for identifying whether a device is a universal serial bus (USB) typed or a mobile high-definition link (MHL) typed device, wherein the device is connected to the apparatus through a connector comprising a first data pin and a voltage-reference pin, comprising:
a first switch having a first terminal and a second terminal; and
a first resistor-detecting module having a third terminal and a fourth terminal, wherein the first resistor-detecting module and the first switch are connected in series, wherein a first conductive path is formed from a first voltage-supply node, through the first resistor-detecting module and the first switch, to the first data pin when the first switch is turned on, wherein the device is the USB typed device when a voltage level at the first data pin is less than a pre-defined voltage level and the device is the MHL typed device if the voltage level at the first data pin is not less than the pre-defined voltage level.

2. The apparatus as cited in claim 1, wherein the third terminal of the first resistor-detecting module is connected to the first voltage-supply node; the fourth terminal of the first resistor-detecting module is connected to the first terminal of the first switch; and the second terminal of the first switch is connected to the first data pin.

3. The apparatus as cited in claim 1, wherein the first terminal of the first switch is connected to the first voltage-supply node; the second terminal of the first switch is connected to the third terminal of the resistor-detecting module; and the fourth terminal of the resistor-detecting module is connected to the first data pin.

4. The apparatus as cited in claim 1, wherein the connector further comprises a second data pin, wherein the first data pin and the second data pin form a pair of differential signals, further comprising:
a second switch having a fifth terminal and a sixth terminal; and
a second resistor-detecting module having a seventh terminal and a eighth terminal, wherein a second conductive path is formed from the first voltage-supply node, through the second resistor-detecting module and the second switch, to the second data pin to detect if there is a pull-down resistor connected from the second data pin to the voltage-reference node when the second switch is turned on.

5. The apparatus as cited in claim 1, wherein the device is the universal serial bus (USB) typed device with a first pull-down resistor connected from the first data pin to the voltage-reference pin, wherein the first resistor-detecting module comprises a first resistor, wherein the first resistor and the first pull-down resistor form a voltage divider from the first voltage-supply node to the voltage-reference node when the first switch is turned on.

6. The apparatus as cited in claim 1, wherein the connector further comprises a voltage-supply pin and the device is the universal serial bus (USB) typed device with a first pull-down resistor connected from the first data pin to the voltage-reference pin, wherein the voltage-supply pin is connected to a second voltage-supply node and the first resistor-detecting module comprises a first resistor, wherein the first resistor and the first pull-down resistor form a voltage divider from the first voltage-supply node to the voltage-reference node when the first switch is turned on.

7. The apparatus cited in claim 1, further comprising:
a USB transceiver;
an MHL transmitter; and
a multiplexer to select either the USB transceiver or the MHL transmitter according to the voltage at the first data pin when the first switch is turned on, wherein the USB transceiver is selected if the voltage at the first data pin is lower than the pre-defined voltage.

8. The apparatus as cited in claim 1, wherein the connector further comprises a voltage-supply pin and the device is the mobile high-definition link (MHL) typed device with a pull-up resistor connected from the first data pin to a third voltage-supply node, wherein the voltage-supply pin is connected to the second voltage-supply node and the first resistor-detecting module comprises a first resistor, wherein the voltage at the first data pin is not less than the pre-defined voltage when the first switch is turned on.

9. The apparatus as cited in claim 1, wherein the connector further comprises a voltage-supply pin and a control pin; and the device is the mobile high-definition link (MHL) typed device, wherein the voltage-supply pin is not connected to a second voltage-supply node, wherein the apparatus further comprises an impedance-detecting module to detect a pull-down resistor connected from the control pin to the voltage-reference pin.

10. The apparatus as cited in claim 9, wherein the impedance-detecting module comprises a first resistor connected from the control pin to a fourth voltage-supply node; a first comparator to generate a first output, wherein the first comparator compares a first reference voltage to the voltage at the control pin; and a second comparator to generate a second output, wherein the second comparator compares the voltage at the control pin to a second reference voltage, whereby the resistance of the pull-down resistor is obtained according to the first output and the second output.

11. The apparatus as cited in claim 9, wherein the impedance-detecting module comprises a first resistor in series with a second switch connecting the control pin to a fourth voltage-supply node; a second resistor in series with a third switch connecting the control pin to the fourth voltage-supply node; and a first comparator to generate a first output when the second switch is turned on and the third switch is turned off and a second output when the second switch is turned off and the third switch is turned on, wherein the resistance of the pull-down resistor is obtained according to the first output and the second output.

12. A method for identifying whether a device is a universal serial bus (USB) typed or a mobile high-definition link (MHL) typed device, wherein the device is connected to an apparatus through a connector comprising a first data pin, a voltage-supply pin, a voltage-reference pin and a control pin, comprising the steps of:
providing a first switch;
providing a first resistor-detecting module, wherein the first resistor-detecting module and the first switch are connected in series;
turning on the first switch to establish a first conductive path from a first voltage-supply node, through the first resistor-detecting module and the first switch, to the first data pin; and
comparing a voltage level of the first data pin to a first pre-defined voltage level when the first switch is turned on, wherein the device is the USB typed device when a voltage level at the first data pin is less than the first pre-defined voltage level and the device is the MHL typed device if the voltage level at the first data pin is not less than the first pre-defined voltage level.

13. The method as cited in claim 12, further comprising the step of:
detecting if the voltage-supply pin is connected to a second voltage-supply node.

14. The method as cited in claim 13, further comprising the step of:
detecting if a first pull-down resistor, with resistance around 1K ohms, is connected from the control pin to the voltage-reference pin.

15. The method as cited in claim 12, further comprising the step of:
selecting either a USB transceiver or an MHL transmitter, wherein the USB transceiver is selected if the voltage of the first data pin is lower than the first pre-defined voltage level.

16. The method as cited in claim 12, further comprising the step of:
turning off the first switch.

17. The method as cited in claim 12, wherein the connector further comprises a second data pin, wherein the first data pin and the second data pin form a pair of differential signals, further comprising the steps of:
providing a second switch;
providing a second resistor-detecting module, wherein the second resistor-detecting module and the second switch are connected in series;
turning on the second switch to establish a second conductive path from the first voltage-supply node, through the second resistor-detecting module and the second switch, to the second data pin; and
comparing the voltage level of the second data pin to a second pre-defined voltage level when the second switch is turned on.

18. The method as cited in claim 13, further comprising the step of:
selecting either a USB transceiver or an MHL transmitter, wherein the MHL transmitter is selected when the voltage of the first data pin is not less than the first pre-defined voltage level and the voltage-supply pin is connected to the second voltage-supply node.

19. The method as cited in claim 14, further comprising the step of:
selecting either a USB transceiver or an MHL transmitter, wherein the MHL transmitter is selected when the first pull-down resistor, with resistance around 1K ohms, is connected from the control pin to the voltage-reference pin.

20. The method as cited in claim 17, further comprising the step of:
turning off the second switch.
